(19) United States
(12) Patent Application Publication
(10) Pub. No.: US 2026/0099003 A1
(43) Pub. Date: Apr. 9, 2026

(54) III-V photonic device integrated on silicon

(71) Applicant: COMMISSARIAT À L'ENERGIE ATOMIQUE ET AUX ENERGIES ALTERNATIVES, PARIS (FR)

(72) Inventors: Joan RAMIREZ, PALAISEAU (FR); Leopold VIROT, GRENOBLE (FR)

(21) Appl. No.: 19/337,884

(22) Filed: Sep. 23, 2025

(30) Foreign Application Priority Data
Oct. 3, 2024 (FR) 2410691

(51) Int. Cl. G02B 6/122; G02B 6/12; G02B 6/13

(52) U.S. Cl. CPC G02B 6/1228; G02B 6/13; G02B 2006/12061

(57) ABSTRACT

A photonic device includes a first waveguide having a core made of a III-V type semiconductor material; a second waveguide having a silicon core; a coupling structure including: a first extension of the core of the first waveguide; a second extension of the core of the second waveguide disposed below the first extension and disposed opposite the first extension; a coating structure made of a coating material having a refractive index ranging between: on the one hand, the refractive index of silicon, and, on the other hand, the highest refractive index in the core of the second waveguide; the coating structure being disposed between the second extension and the first extension at least in the stacking direction.

### CROSS-REFERENCE TO RELATED APPLICATION

This application claims priority to foreign French patent application No. FR 2410691, filed on Oct. 3, 2024, the disclosure of which is incorporated by reference in its entirety.

### FIELD OF THE INVENTION

The invention relates to a heterogeneous photonic device made up of III-V type semiconductor optical components co-integrated with silicon optical components on silicon substrates.

### BACKGROUND

Many fabrication techniques have been developed with a view to producing microstructures and nanostructures on semiconductor substrates, thus allowing integrated circuits and systems to be created. These systems cover a wide range of applications, including transistor-based microelectronic circuits, microsystems such as MEMS (Micro-Electro-Mechanical Systems) or NEMS (Nano-Electro-Mechanical Systems), integrated sensors (such as pressure sensors, accelerometers, chemical sensors, etc.), as well as photonic and optoelectronic systems integrated on a semiconductor substrate.

More specifically, photonic circuits can be produced that integrate laser emitters associated with layers for processing the emitted beams (guidance, multiplexing/demultiplexing, amplification, etc.), with these processing layers being deposited onto a silicon substrate (commonly called “photonic on silicon”).

The integration of laser sources and optical amplifiers on silicon photonic circuits has evolved rapidly in recent years, driven by the increasing need for integrated photonic circuits in various fields, such as optical communications, detection, quantum computing, or even programmable photonics. The integration of III-V semiconductor-based lasers and amplifiers on silicon wafers combines the versatility, the high density and the ease of large-scale production of CMOS technology with the increased performance capabilities obtained through the use of III-V type semiconductor materials. This is then referred to as heterogeneous integration of III-V type semiconductor photonic components and silicon photonic components. Heterogeneous integration remains the most appropriate option for implementing III-V lasers and amplifiers on silicon with high production volume and advanced technological maturity.

The integration of lasers and amplifiers on a chip requires efficient optical mode transition between the III-V type material and the passive silicon photonic platform. As a general rule, adiabatic cones are used to minimize any optical losses during this transition. To this end, a phase matching condition is required. By way of an illustrative example, FIG. 1a shows a top view, along the (X, Y) plane, of a photonic device DO of the prior art produced by stacking layers on a silicon substrate (not shown). The layers are stacked in the Z direction, perpendicular to the (X, Y) plane. The photonic device DO comprises a first waveguide WG1′ having a core made of III-V semiconductor material and a second waveguide WG2′ with a silicon core. The photonic device DO also comprises an optical coupling structure SC′ for transferring at least part of an optical signal propagated from the first waveguide WG1′ to the second waveguide WG2′, or vice versa. The optical coupling structure SC′ comprises a first extension 10′ of the core of the first waveguide WG1′ and a second extension 20′ of the core of the second waveguide WG2′, disposed below the first extension 10′. These two extensions 10′, 20′ are positioned at different heights along the Z axis and are placed opposite each other in order to define an overlapping zone. The transfer of the optical signal from one waveguide to the next occurs in this overlapping zone ZC (also called coupling zone). In order to achieve effective optical coupling between these two extensions, the effective refractive index for the mode confined in the second waveguide WG2′ must be at least as large as the effective index of the mode confined in the first waveguide WG1′, which constitutes optical coupling. At equal dimensions, the effective propagation index in silicon is much lower than that in III-V material. Thus, in order to equalize the effective propagation indices in the opposing regions of silicon and III-V material, the dimensions of the silicon region need to be increased. This increases the footprint of the optical coupler, in particular the thickness of the silicon extension.

Several problems have been clearly identified in the photonic circuits of the prior art. Indeed, optical coupling between a III-V component and a silicon waveguide requires a thickness of approximately 500 nm for the silicon waveguide. However, industrial silicon-based photonic platforms have inherent limitations for the development of integrated III-V lasers and amplifiers, as silicon photonic circuits have geometric dimensions that are only optimized for passive functions. In particular, the height of the silicon waveguides is limited to 220 nm or 300 nm in industrial foundries, which is a major constraint. III-V active devices integrated on silicon waveguides with a thickness of less than 500 nm exhibit poor performance capabilities due to very limited optical signal transfer between the III-V components and the silicon components, or vice versa. This results in significant optical signal losses during the transition between an active (III-V) component and a passive (silicon) component.

FIG. 1b illustrates the simulation results of the optical transition for a silicon waveguide with a thickness of 500 nm, 300 nm and 220 nm in a device according to the prior art. The use of a 500 nm thick silicon waveguide (left-hand side) allows efficient coupling between the III-V waveguide and the silicon waveguide, with an optical mode that is almost entirely confined in the silicon waveguide at the end of the transition. However, thickening the silicon waveguide requires additional deposition steps, making the manufacturing process slower, more complex and more expensive. However, using standard thicknesses of 300 nm and 220 nm for the silicon waveguide significantly reduces the efficiency of the optical signal transfer. At the outlet of the coupling zone, a significant proportion of the optical signal still remains confined in the III-V semiconductor waveguide, resulting in a significant loss of the optical signal to be propagated in the silicon waveguide.

### PRIOR ART/LIMITATIONS OF THE PRIOR ART

Document FR 3127825 A1 discloses a photonic chip and a method for manufacturing this photonic chip.
Scientific publication [1] describes a solution that involves inserting an additional layer of polycrystalline silicon between the silicon waveguide and the III-V type semiconductor waveguide in order to improve optical coupling. This approach is incompatible with standard silicon manufacturing methods due to the need for high-temperature thermal annealing for crystallizing the additional inserted layer. Thermal annealing results in the degradation of the optical properties of the photonic circuit and increases any losses in the propagated optical signal.
Scientific publication [2] describes a solution that involves microstructuring the extension of the silicon waveguide so as to obtain a periodic sawtooth structure in the coupling zone. The disadvantage of this approach is that the microstructuring operation makes the manufacturing method more complex. Furthermore, introducing an uneven rough surface into the silicon waveguide causes optical losses, which reduces the transmission performance capabilities.
Scientific publication [3] describes a solution that involves significantly reducing the thickness of the III-V semiconductor waveguide in the overlapping zone by placing the charge injection electrodes of the III-V active component on either side of said overlapping zone. This solution has several disadvantages. The first disadvantage is the requirement for an additional step of growing III-V layers in order to create the N- and P-doped zones on each side. Such an epitaxial growth operation can result in the degradation of the silicon waveguide due to its thermal budget. The second disadvantage is the injection of a lateral current, which introduces higher resistance. The third disadvantage relates to lateral injection, which makes it impossible to use the Quantum Confined Stark Effect (QCSE) when developing electro-absorption modulated lasers.

### Response to the Problem and Solution Provided

In order to overcome the limitations of existing solutions, the invention proposes a structure for coupling an active III-V semiconductor component to a waveguide with a silicon core comprising a coating structure for said core. The coating structure allows the amount of the transmitted optical signal to be increased without increasing the thickness of the silicon core. This significantly reduces the footprint of the silicon-integrated photonic device and simplifies the manufacturing method, which can be based on standard silicon wafers without additional deposition of silicon.

In general, the invention provides an effective solution for coupling the optical mode of a III-V waveguide to an industrial photonic platform made of silicon. From a manufacturing perspective, it is a simple solution that does not involve any etching or regrowth of the silicon photonic platform, which can add complexity and additional risk to the functionality.

From an optical perspective, the losses of the propagated optical signal after a transition are very negligible at the outlet of the coupling structure according to the invention. More specifically, the use of a coating structure made of SiGe within the context of the invention allows a crystalline layer to be grown that is known to have low propagation losses at the target wavelengths. Furthermore, the SiGe coating can be produced using standard silicon foundry methods, which facilitates its implementation and the quality of the coupling structure that is obtained. As the material is already used in standard CMOS foundries, it does not add any risk of contamination and can be easily implemented in an existing production line.

### SUMMARY OF THE INVENTION

The aim of the invention is a photonic device comprising a stack of layers on a substrate in a stacking direction, said stack comprising:
a first waveguide having a core comprising a plurality of stacked layers, with each layer of said plurality of layers being made of a III-V type semiconductor material;
a second waveguide having a silicon core;
an optical coupling structure for transferring at least part of an optical signal propagated from the first waveguide to the second waveguide, or vice versa, with the optical coupling structure comprising:
   a first extension of the core of the first waveguide;
   a second extension of the core of the second waveguide disposed below said first extension and disposed opposite said first extension;
   a coating structure made of a coating material having a refractive index ranging between:
      on the one hand, the refractive index of silicon; and, on the other hand, the highest refractive index from among those of said III-V type semiconductor materials, for a predetermined wavelength;
         the coating structure being disposed between the second extension and the first extension at least in the stacking direction.

According to one particular aspect of the invention, the coating structure comprises a first coating layer disposed on an upper surface of the second extension.

According to one particular aspect of the invention, the coating structure further comprises a second coating layer disposed on a first lateral surface of the second extension and a third coating layer disposed on a second lateral surface of the second extension. The second coating layer and the third coating layer are made up of said coating material.

According to one particular aspect of the invention, the coating material is transparent for a wavelength ranging between 1,520 nm and 1,565 nm and/or for a wavelength ranging between 1,260 nm and 1,360 nm.

According to one particular aspect of the invention, the coating material is silicon-germanium alloy.

According to one particular aspect of the invention, the coating material is silicon-germanium alloy with the formula SiGeₓ, with x ranging between 0.2 and 0.6.

According to one particular aspect of the invention, the thickness of the first coating layer is less than or equal to 130 nm.

According to one particular aspect of the invention, the thickness of the silicon core of the second waveguide is less than or equal to 300 nm.

According to one particular aspect of the invention, the width of the second extension gradually varies.

A further aim of the invention is a method for manufacturing a photonic device according to the invention, comprising the following steps of:
a) manufacturing, on a substrate, a waveguide having a silicon core comprising an extension, on which a coating structure is disposed that is made of a coating material having a refractive index that is greater than that of silicon for a predetermined wavelength;
b) manufacturing a waveguide having a core comprising a plurality of stacked layers, with each layer of said plurality of layers being made of a III-V type semiconductor material, via a series of steps of depositing and etching layers, with the waveguide having an extension disposed opposite the coating structure, with the refractive index of the coating material ranging between:
   on the one hand, the refractive index of silicon;
   and, on the other hand, the highest refractive index from among those of said III-V type semiconductor materials, for a predetermined wavelength.

According to one particular aspect of the invention, the manufacturing step a) comprises the following sub-steps of:
providing a substrate, on which a waveguide with a silicon core is disposed, with said waveguide being encapsulated in a dielectric layer;
etching the dielectric layer so as to expose at least one upper surface of the waveguide;
depositing, onto said upper surface, a first coating layer made of a coating material having a refractive index that is greater than that of silicon for a predetermined wavelength.

According to one particular aspect of the invention, the etching step is carried out so as to further expose at least a portion of a first lateral surface and a second lateral surface of said waveguide having a silicon core.

According to one particular aspect of the invention, the depositing sub-step further comprises depositing a second coating layer onto the exposed portion of the first lateral surface and a third coating layer onto the exposed portion of the second lateral surface, with the second coating layer and the third coating layer being made up of said coating material.

According to one particular aspect of the invention, the manufacturing step a) comprises the following sub-steps of:
providing a substrate, on which a starting layer of silicon is disposed;
depositing, onto the starting layer, a first coating layer made of a coating material having a refractive index that is greater than that of silicon for a predetermined wavelength;
etching the stack formed by the starting layer and the first coating layer so as to structure a waveguide having a silicon core with an upper surface, on which the first coating layer is disposed.

According to one particular aspect of the invention, the manufacturing step a) comprises the following sub-step of: encapsulating the assembly formed by the waveguide having a silicon core and the coating structure in a dielectric layer.

### BRIEF DESCRIPTION OF THE DRAWINGS

Further features and advantages of the present invention will become more clearly apparent on reading the following description, with reference to the following appended drawings.

FIG. 1a illustrates a top view of a photonic device according to the prior art. This figure has already been described.

FIG. 1b illustrates the simulation results of the optical transition for a silicon waveguide with a thickness of 500 nm, 300 nm and 220 nm in a device according to the prior art. This figure has already been described.

FIG. 2a illustrates a cross-sectional view of the photonic device according to the invention in the coupling zone.

FIG. 2b illustrates a top view of the photonic device according to the invention in the coupling zone.

FIG. 3 illustrates the evolution curves of the optical signal remaining in the active waveguide (in III-V), as a function of the evolution of the width of the silicon waveguide in the coupling zone, for a plurality of devices according to the invention and according to the prior art.

FIG. 4a illustrates the steps of a first method for manufacturing the photonic device according to the invention.

FIG. 4b illustrates the steps of a second method for manufacturing the photonic device according to the invention.

FIG. 4c illustrates the steps of a third method for manufacturing the photonic device according to the invention.

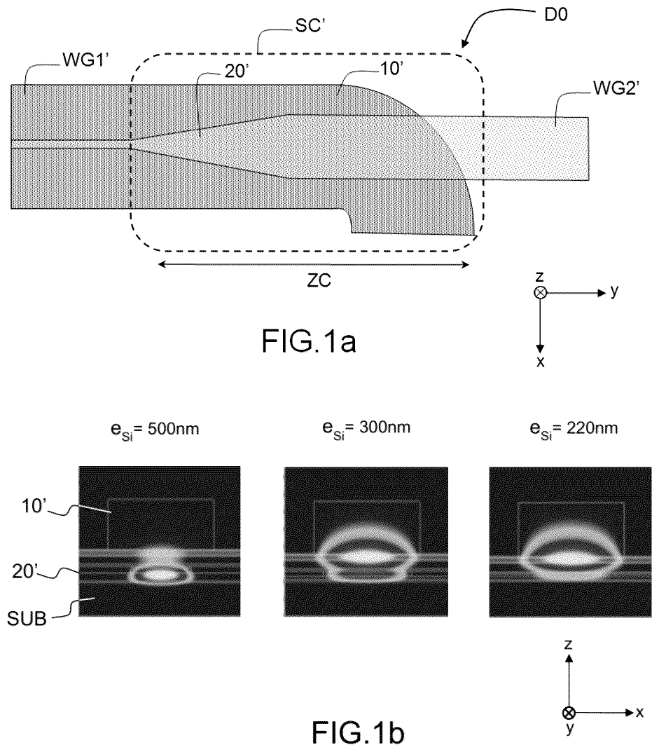

### DETAILED DESCRIPTION

In the figures illustrating the invention, the horizontal is represented by the X and Y directions of an orthogonal (X, Y, Z) coordinate system. The Z direction of this orthogonal coordinate system represents the vertical direction. Hereafter, terms such as “upper”, “lower”, “above”, “below”, “top” and “bottom” are defined relative to this Z direction. The terms “left” and “right” are defined relative to the X direction. The terms “front” and “rear” are defined relative to the Y direction. Hereafter, the term “thickness” refers to the maximum thickness of an element in the Z direction, called stacking direction. The term “width” refers to the dimension of a layer in the X direction.

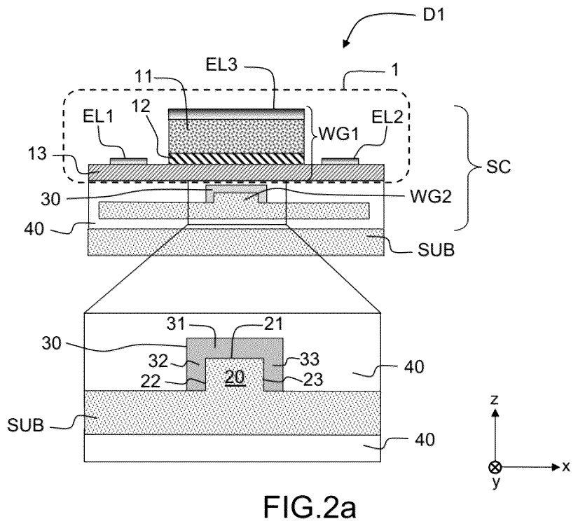

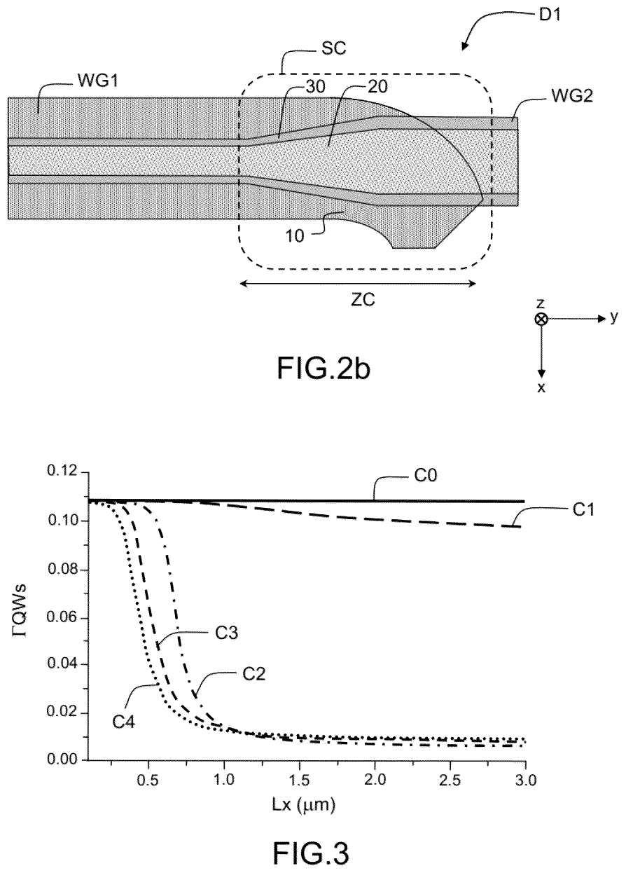

FIG. 2a illustrates a cross-sectional view, along the (X, Z) plane, of the photonic device D1 according to the invention in the vicinity of the coupling zone ZC. FIG. 2b illustrates a top view, along the (X, Y) plane, of the photonic device D1 according to the invention in the vicinity of the coupling zone ZC. The photonic device D1 comprises an active component 1 formed by a stack of layers of III-V type semiconductor materials, disposed on a waveguide WG2 with a silicon core. The silicon core is encapsulated in a dielectric layer 40 with a refractive index that is lower than silicon, for example of SiO₂. The assembly is disposed on a substrate SUB, defining a “substrate plane” parallel to the (X, Y) plane.

By way of an example, the active component 1 is a laser source or an amplifier or a modulator of an optical signal. The active component 1 comprises a strip heterostructure for generating and/or guiding an electromagnetic wave, a first electrode EL1, a second electrode EL2 and a third electrode EL3. The strip heterostructure comprises a waveguide WG1 comprising a lower confinement layer 13, an upper confinement layer 11 and an active layer 12. The active layer 12 is confined between the lower confinement layer 13 and the upper confinement layer 11. The upper confinement layer 11 is made of a first III-V type semiconductor material, by way of an example P-doped InP or P-doped GaAs. The lower confinement layer 13 is made of a second III-V type semiconductor material, for example N-doped InP or N-doped GaAs. The active layer 12 is made of a third semiconductor material having an energy gap value Eg₁₂. Advantageously, the active layer 12 is made of a ternary or quaternary III-V type alloy, for example InGaAsP or InGaAlAs. Alternatively, the active zone 12 is made of a stack of alternating layers of different compositions of III-V type ternary or quaternary alloys. The thickness of each layer of said stack is from a few nm to around ten nm so as to form a series of quantum wells (“multi-quantum well layers”). The width of the lower confinement layer 13 is greater than that of the active layer 12 and the upper confinement layer 11 so as to form a guide strip (corresponding to layers 11, 12) disposed on a base (corresponding to the lower confinement layer 13).

The first waveguide WG1 extends in a guide direction Y orthogonal to the stacking direction Z. The second waveguide WG2 extends in the same guide direction Y orthogonal to the stacking direction Z. Alternatively, the second waveguide WG2 extends in a guide direction Y different from that of the first waveguide WG1 and orthogonal to the stacking direction Z.

In the case of an active layer formed by a bulk layer, the energy gap value Eg₁₂ of the material forming the active layer 12 is lower than the energy gap value Eg₁₁ of the upper confinement layer 11 and the energy gap value Eg₁₃ of the lower confinement layer 13. In the case of an active layer formed by stacking alternating layers, the materials forming the layers of the alternating stack each have an energy gap value that is lower than the energy gap value Eg₁₁ of the upper confinement layer 11 and the energy gap value Eg₁₃ of the lower confinement layer 13.

The third electrode EL3 is a layer of electrically conductive material disposed on the upper surface of the upper confinement layer. The first and second electrodes EL1, EL2 are two layers of electrically conductive material disposed on the lower confinement layer 13, on either side of the guide strip. The electrodes EL1, EL2 and EL3 are intended to be connected to an external electrical generator, not shown. Applying an electrical voltage between the third electrode EL3, on the one hand, and the electrodes EL1, EL2, on the other hand, allows positive charge carriers (holes) to be injected into the volume of the upper confinement layer and negative charge carriers (electrons) to be injected into the volume of the lower confinement layer 13. The charged carriers with opposite signs are confined in the active layer 12 with a small gap, where they recombine. The recombination of electrons and holes in the active layer 12 allows photons to be emitted at a wavelength corresponding to the energy gap value Eg₁₂. The photons emitted by the recombination of injected charge carriers are confined in said layers and form an electromagnetic wave that propagates in the waveguide WG1 in the guide direction Y.

The photonic device D1 further comprises an optical coupling structure SC for transferring at least part of an optical signal propagated from the first waveguide WG1 to the second waveguide WG2, or vice versa. The optical coupling structure SC according to the invention comprises a first extension 10 of the core of the first waveguide WG1, a second extension 20 of the core of the second waveguide WG2 and a coating structure 30.

The second extension 20 is disposed below the first extension 10. These two extensions 10, 20 are positioned at different heights along the Z axis and are placed opposite each other in order to define an overlapping zone, also called coupling zone ZC. The transfer of the optical signal from one waveguide to the next occurs in this coupling zone ZC. In order to achieve effective optical coupling between these two extensions, the effective refractive index for the mode confined in the second waveguide WG2 must be at least as large as the effective index of the mode confined in the first waveguide WG1. The coating structure 30 is made of a coating material with a refractive index n₃₀ ranging between, on the one hand, the refractive index of silicon and, on the other hand, the highest refractive index from among the semiconductor materials forming each of the III-V semiconductor layers of the first extension 10, i.e. from among the layers of the stack 11, 12, 13. The coating structure 30 is disposed between the second extension 20 and the first extension 10 so as to separate them. The coating structure 30 allows the amount of optical signal transmitted from the first waveguide WG1 to the second waveguide WG2, or vice versa, to be increased, thereby achieving a transfer of the optical, adiabatic mode transfer, without increasing the thickness of the silicon core. Thus, it is possible for the active component 1 to transition toward the silicon photonic array, while maintaining a standard silicon core thickness that is less than or equal to 300 nm. This avoids an additional step of silicon growth and thermal annealing in the manufacturing method, thereby simplifying it and avoiding any degradation due to thermal annealing.

In the coating structure 30 according to the invention, the width Lx of the second extension 20 in the X direction gradually increases as it advances into the coupling zone ZC when the optical coupling structure SC is intended to transition from the first waveguide WG1 of the active component 1 made of a III-V semiconductor to the second silicon waveguide WG2 connected to the silicon photonic array. Conversely, the width Lx of the second extension 20 in the X direction gradually decreases as it advances into the coupling zone ZC when the optical coupling structure SC is intended to transition from the second silicon waveguide WG2 connected to the silicon photonic array to the first waveguide WG1 of the active component 1 made of a III-V semiconductor. The coating structure 30 also allows transition rates to be achieved of more than 90% for an extension widening that is less than or equal to 2 μm.

Advantageously, the first extension 10 extends in a non-rectilinear direction with a non-zero curvature relative to the initial guide direction Y at the end of the coupling zone ZC. This prevents any interference between the residual optical signal in the first waveguide WG1 and the optical signal transmitted to the second waveguide WG2 at the outlet of the coupling structure ZC.

The coating structure 30 comprises a first coating layer 31 disposed on the upper surface 21 of the second silicon extension 20. The first coating layer 31 has a refractive index no ranging between, on the one hand, the refractive index of silicon and, on the other hand, the highest refractive index from among the semiconductor materials forming the III-V semiconductor layers of the first extension 10, i.e. from among the layers of the stack 11, 12, 13, for wavelengths ranging between 1,520 nm and 1,565 nm and/or between 1,260 nm and 1,360 nm. The first coating layer 31 separates the first extension 10 from the second extension 20 so as to allow a better transition rate to be provided for the optical signal from one waveguide to the next.

Advantageously, the coating material is transparent for a wavelength ranging between 1,520 nm and 1,565 nm and/or for a wavelength ranging between 1,260 nm and 1,360 nm. This prevents absorption of the optical signal propagated in the coating structure 30 during a transition.

Advantageously, the first coating layer 31 is made of SiGe. The use of SiGe as a coating material has been shown to provide a more efficient optical transition compared to other materials. More advantageously, the coating material is silicon-germanium alloy with the formula Si₍₁₋ₓ₎Geₓ, with x ranging between 0.2 and 0.6. This concentration range provides a refractive index ranging between 3.6 and 4.05, while having a light absorption rate of less than 0.1% for wavelengths ranging between 1,520 nm and 1,565 nm.

Advantageously, the thickness of the first coating layer 31 is less than or equal to 130 nm. This avoids the risk of confining the optical signal in the coating structure 30 after a transition operation through the coupling structure SC.

According to one embodiment of the invention, the coating structure 30 further comprises a second coating layer 32 disposed on a first lateral surface 22 of the second extension 20 and a third coating layer 33 disposed on a second lateral surface 23 of the second extension 20. The second coating layer 32 and the third coating layer 33 are both made up of the coating material. This results in a coating structure that covers all the external surfaces (upper and lateral) of the silicon core of the second waveguide WG2. This increases the effective refractive index of the second waveguide WG2. Indeed, the confined optical mode has an effective refractive index that is the average of its surrounding refractive indices. The high-index lateral walls 32, 33 increase the value of the effective refractive index, which makes the transition more efficient.

FIG. 3 illustrates the evolution curves of the optical signal remaining in the active waveguide (in III-V), as a function of the evolution of the width of the silicon waveguide in the coupling zone, for a plurality of devices according to the invention and according to the prior art. The increase in the width of the silicon waveguide in the coupling zone reflects the advancement in the coupling zone in the Y direction, since the second extension increases gradually (conical shape in FIG. 2b). The curve C0 corresponds to a coupling structure according to the prior art without a 220 nm thick coating structure for the silicon core. The curve C1 corresponds to a coupling structure according to the prior art without a 300 nm thick coating structure for the silicon core. The curve C2 corresponds to a coupling structure according to the prior art without a 500 nm thick coating structure for the silicon core. The curve C3 corresponds to a coupling structure according to the invention with a 100 nm thick SiGe coating structure and with a 300 nm thickness for the silicon core. The curve C4 corresponds to a coupling structure according to the invention with a 130 nm thick SiGe coating structure and with a 220 nm thickness for the silicon core. The curves C1 and C0 show that at least 10% of the optical signal remains confined in the first waveguide WG1 of the active component 1 along the entire coupling structure, thereby demonstrating that the transition has not been correctly achieved in the solutions of the prior art. The curve C2 exhibits an effective transition, where the residual signal in the first waveguide WG1 reaches 2% at a width of Lx=1 μm. However, the optical coupling structure of the curve C2 requires an additional growth step for the silicon core in order to reach 500 nm. The curve C3 exhibits an effective transition, where the residual signal in the first waveguide reaches 2% at a width of Lx=0.7 μm. This indicates a faster transition than that of the curve C2, for a thinner silicon core. The curve C4 exhibits an effective transition, where the residual signal in the first waveguide reaches 2% at a width of Lx=0.6 μm. This indicates a more effective transition than that of the curve C2, allowing a less bulky optical coupling structure SC to be provided for a thinner silicon core.

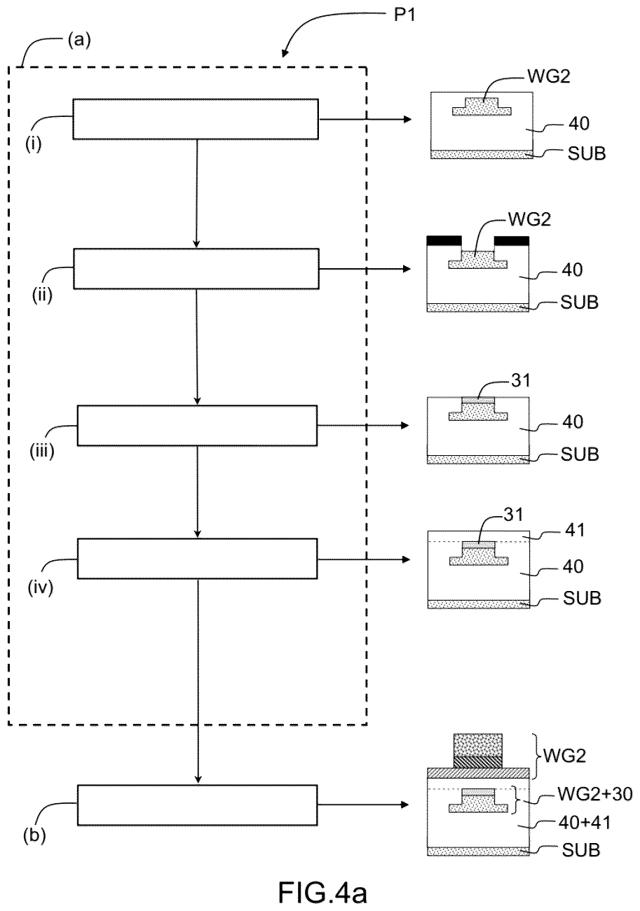

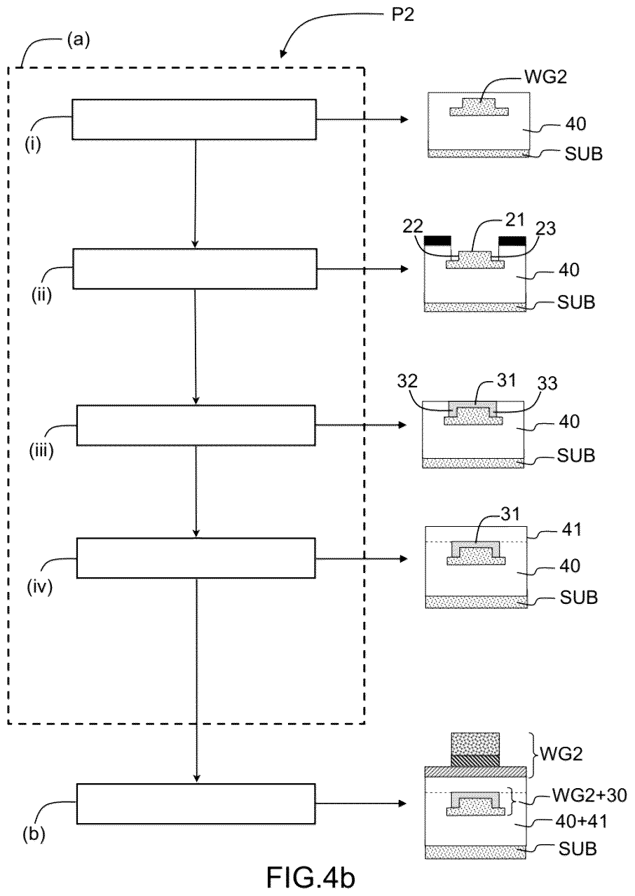

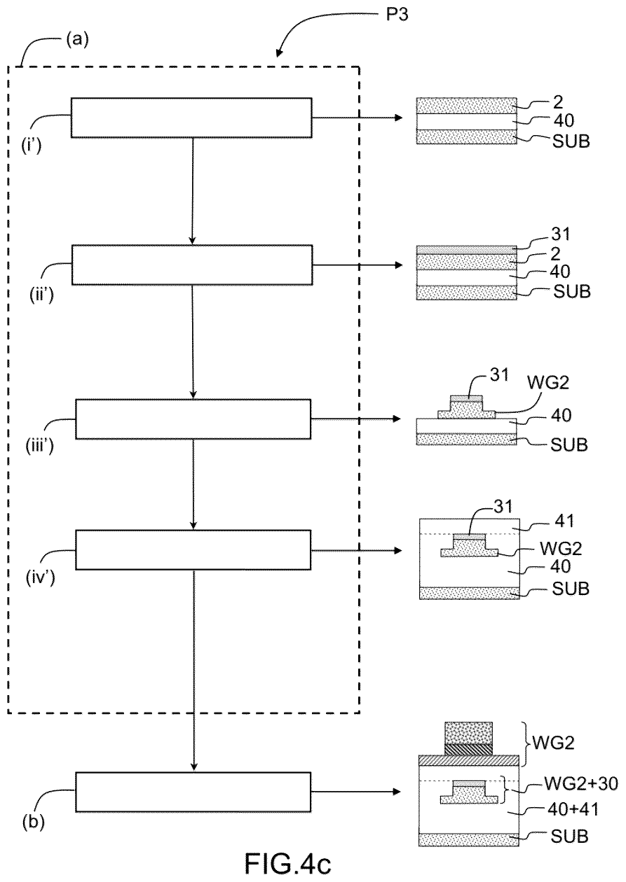

FIG. 4a illustrates the steps of a first method P1 for manufacturing the photonic device according to the invention.

The first step a) involves manufacturing a waveguide WG2 with a silicon core on a substrate SUB. The silicon core comprises at least one extension 20, on which a coating structure 30 is disposed that is made of a coating material with a refractive index n₃₀ that is greater than that of silicon for a predetermined wavelength, for example ranging between 1,520 nm and 1,565 nm or ranging between 1,260 nm and 1,360 nm. Step a) comprises the following sequence of sub-steps.

A first sub-step (i) involves providing a substrate SUB, on which a waveguide WG2 with a silicon core is disposed. The waveguide WG2 is encapsulated in a dielectric layer 40. Next, a second sub-step (ii) involves etching the dielectric layer 40 so as to expose at least one upper surface 21 of the waveguide WG2 in the vicinity of an extension 20 of the core of said waveguide WG2. The etching is carried out by a sequence of resin deposition, lithography and etching operations in order to define the zones to be etched. Next, the third sub-step (iii) involves depositing, onto said upper surface 21, a first coating layer 31 made of a coating material with a refractive index n₃₀ that is greater than that of silicon. The first coating layer 31 forms the coating structure 30. For example, the third sub-step (iii) involves epitaxially growing a coating layer of Si₍₁₋ₓ₎ Geₓ on the upper surface 21, preferably with x being between 0.2 and 0.6. Step a) further comprises an optional sub-step (iv), which involves encapsulating the obtained assembly in a dielectric layer 41, for example made of SiO₂.

The second step (b) involves manufacturing a waveguide WG1 with a core made of a III-V type semiconductor material by means of a series of layer deposition and etching steps. The waveguide WG1 has an extension 10 disposed opposite the coating structure 30. The refractive index of the coating material is lower than that of the III-V type semiconductor material for the target wavelength range. The assembly formed by the extension 10, the extension 20 and the coating structure 30 forms an optical coupling structure SC in a coupling zone ZC.

FIG. 4b illustrates the steps of a second method P2 for manufacturing the photonic device according to the invention.

The first step a) involves manufacturing a waveguide WG2 with a silicon core on a substrate SUB. The silicon core comprises at least one extension 20, on which a coating structure 30 is disposed that is made of a coating material with a refractive index n₃₀ that is greater than that of silicon for a predetermined wavelength, for example ranging between 1,520 nm and 1,565 nm or ranging between 1,260 nm and 1,360 nm. Step a) comprises the following sequence of sub-steps.

The first sub-step (i) is similar to that described for the first method P1. Next, the second sub-step (ii) involves etching the dielectric layer 40 so as to expose an upper surface 21 of the waveguide WG2 in the vicinity of an extension 20 of the core of said waveguide WG2. Furthermore, said etching of the sub-step (ii) is carried out so as to further expose at least a portion of a first lateral surface 22 and a second lateral surface 23 of the waveguide WG2 with a silicon core. The etching is carried out by a sequence of resin deposition, lithography and etching operations in order to define the zones to be etched. Next, the third sub-step (iii) involves depositing a first coating layer 31 onto said upper surface 21, a second coating layer 32 onto the first lateral surface 22 and a third coating layer 33 onto the second lateral surface 23. The first coating layer 31, the second coating layer 32 and the third coating layer 33 are made of a coating material with a refractive index nso that is greater than that of silicon and together form the coating structure 30. For example, the third sub-step (iii) involves epitaxially growing a coating layer of Si₍₁₋ₓ₎Geₓ on the outer surfaces of the silicon core, preferably with x being between 0.2 and 0.6. Step a) further comprises an optional sub-step (iv) similar to the encapsulation step of the first method P1.

The second step (b) involves manufacturing a waveguide WG1 with a core made of a III-V type semiconductor material similar to step (b) of the first method P1.

FIG. 4c illustrates the steps of a third method P3 for manufacturing the photonic device according to the invention.

The first step a) involves manufacturing a waveguide WG2 with a silicon core on a substrate SUB. The silicon core comprises at least one extension 20, on which a coating structure 30 is disposed that is made of a coating material with a refractive index n₃₀ that is greater than that of silicon for a predetermined wavelength, for example ranging between 1,520 nm and 1,565 nm or ranging between 1,260 nm and 1,360 nm. Step a) comprises the following sequence of sub-steps.

The first sub-step (i′) involves providing a substrate SUB, on which a starting layer 2 of silicon is disposed. Next, the second sub-step (ii′) involves depositing, onto the starting layer 2, a first coating layer 31 made of a coating material with a refractive index nso that is greater than that of silicon.

The third sub-step (iii′) involves etching the stack formed by the starting layer 2 and the first coating layer 31 so as to structure a waveguide WG2 having a silicon core with an upper surface 21, on which the first coating layer 31 is disposed. The first coating layer 31 forms the coating structure 30. Step a) further comprises an optional sub-step (iv′) similar to the encapsulation step (iv) of the first method P1. The second step (b) involves manufacturing a waveguide WG1 with a core made of a III-V type semiconductor material similar to step (b) of the first method P1.

### REFERENCES

[1] Zhang, J., Haq, B., O'Callaghan, J., Gocalinska, A., Pelucchi, E., Trindade, A. J. & Roelkens, G. (2018). Transferprinting-based integration of a III-V-on-silicon distributed feedback laser. Optics express, 26 (7), 8821-8830
[2] T. Thiessen et al., “Back-Side-on-BOX Heterogeneously Integrated III-V-on-Silicon O-Band Distributed Feedback Lasers”, J. Light. Technol., vol. 38, no. 11, pp. 3000-3006 June 2020, doi: 10.1109/JLT.2020.2978413.
[3] T. Aihara et al., “Membrane buried-heterostructure DFB laser with an optically coupled III-V/Si waveguide”, Opt. Express, vol. 27, no. 25, p. 36438, December 2019, doi: 10.1364/oe.27.036438.

1. A photonic device (D1) comprising a stack of layers on a substrate (SUB) in a stacking direction (Z), said stack comprising:
a first waveguide (WG1) having a core comprising a plurality of stacked layers, with each layer of said plurality of layers, being made of a III-V type semiconductor material;
a second waveguide (WG2) having a silicon core;
an optical coupling structure (SC) for transferring at least part of an optical signal propagated from the first waveguide (WG1) to the second waveguide (WG2), or vice versa, with the optical coupling structure (SC) comprising:
a first extension of the core of the first waveguide (WG1);
a second extension of the core of the second waveguide (WG2) disposed below said first extension and disposed opposite said first extension;
a coating structure made of a coating material having a refractive index (n₃₀) ranging between:
on the one hand, the refractive index of silicon;
and, on the other hand, the highest refractive index from among those of said III-V type semiconductor materials, for a predetermined wavelength;
the coating structure being disposed between the second extension and the first extension at least in the stacking direction (Z).

2. The photonic device (D1) according to claim 1, wherein the coating structure comprises a first coating layer disposed on an upper surface of the second extension.

3. The photonic device (D1) according to claim 1, wherein the coating structure further comprises a second coating layer disposed on a first lateral surface of the second extension and a third coating layer disposed on a second lateral surface of the second extension, with the second coating layer and the third coating layer being made up of said coating material.

4. The photonic device (D1) according to claim 1, wherein the coating material is transparent for a wavelength ranging between 1,520 nm and 1,565 nm and/or for a wavelength ranging between 1,260 nm and 1,360 nm.

5. The photonic device (D1) according to claim 1, wherein the coating material is silicon-germanium alloy.

6. The photonic device (D1) according to claim 5, wherein the coating material is silicon-germanium alloy with the formula Si₍₁₋ₓ₎Geₓ, with x ranging between 0.2 and 0.6.

7. The photonic device (D1) according to claim 2, wherein the thickness of the first coating layer is less than or equal to 130 nm.

8. The photonic device (D1) according to claim 1, wherein the thickness (e_{Si}) of the silicon core of the second waveguide (WG2) is less than or equal to 300 nm.

9. The photonic device (D1) according to claim 1, wherein the width (Lx(y)) of the second extension gradually varies.

10. A method (P1, P2, P3) for manufacturing a photonic device (D1) according to claim 1, comprising the following steps of:
a) manufacturing, on a substrate (SUB), a waveguide (WG2) having a silicon core comprising an extension, on which a coating structure is disposed that is made of a coating material having a refractive index (n₃₀) that is greater than that of silicon for a predetermined wavelength;
b) manufacturing a waveguide (WG1) having a core comprising a plurality of stacked layers, with each layer of said plurality of layers being made of a III-V type semiconductor material, via a series of steps of depositing and etching layers, with the waveguide (WG1) having an extension disposed opposite the coating structure, with the refractive index (n₃₀) of the coating material ranging between:
on the one hand, the refractive index of silicon;
and, on the other hand, the highest refractive index from among those of said III-V type semiconductor materials, for a predetermined wavelength.

11. The manufacturing method (P1, P2) according to claim 10, wherein the manufacturing step a) comprises the following sub-steps of:
(i) providing a substrate (SUB), on which a waveguide (WG2) with a silicon core is disposed, with said waveguide (WG2) being encapsulated in a dielectric layer;
(ii) etching the dielectric layer so as to expose at least one upper surface of the waveguide (WG2);
(iii) depositing, onto said upper surface, a first coating layer made of a coating material having a refractive index (n₃₀) that is greater than that of silicon for a predetermined wavelength.

12. The manufacturing method (P2) according to claim 11, wherein the etching step (ii) is carried out so as to further expose at least a portion of a first lateral surface and a second lateral surface of said waveguide (WG2) having a silicon core.

13. The manufacturing method (P2) according to claim 12, wherein the depositing sub-step (iii) further comprises depositing a second coating layer onto the exposed portion of the first lateral surface and a third coating layer onto the exposed portion of the second lateral surface, with the second coating layer and the third coating layer being made up of said coating material.

14. The manufacturing method (P3) according to claim 10, wherein the manufacturing step a) comprises the following sub-steps of:
(i′) providing a substrate (SUB), on which a starting layer of silicon is disposed;
(ii′) depositing, onto the starting layer, a first coating layer made of a coating material having a refractive index (n₃₀) that is greater than that of silicon for a predetermined wavelength;
(iii′) etching the stack formed by the starting layer and the first coating layer so as to structure a waveguide (WG2) having a silicon core with an upper surface, on which the first coating layer is disposed.

15. The manufacturing method (P1, P2, P3) according to claim 10, wherein the manufacturing step a) comprises the following sub-step of:
encapsulating (iv, iv′) the assembly formed by the waveguide (WG2) having a silicon core and the coating structure in a dielectric layer.
